(19) United States
(12) Patent Application Publication
(10) Pub. No.: US 2019/0005902 A1
(43) Pub. Date: Jan. 3, 2019

(54) DRIVING METHOD AND DRIVING DEVICE FOR DISPLAY PANEL AND DISPLAY APPARATUS

(71) Applicants: HKC CORPORATION LIMITED, Shenzhen (CN); CHONGQING HKC OPTOELECTRONICS TECHNOLOGY CO., LTD., Jieshi, Banan District (CN)

(72) Inventor: Yu-jen CHEN, Jieshi, Banan District (CN)

(73) Assignees: HKC CORPORATION LIMITED, Shenzhen, GD (CN); CHONGQING HKC OPTOELECTRONICS TECHNOLOGY CO. LTD., JIESHI, BANAN DISTRICT, CQ (CN)

(21) Appl. No.: 15/743,819

(22) PCT Filed: Jun. 19, 2017
(86) PCT No.: PCT/CN2017/088971

§ 371 Date: Jan. 11, 2018

(30) Foreign Application Priority Data
May 5, 2017 (CN) 201710313112.6

(51) Int. Cl. G09G 3/36

(52) U.S. Cl. CPC G09G 3/3607; G09G 2300/0452; G09G 2330/04; G09G 2320/068; G09G 2330/021; G09G 2320/0673

(57) ABSTRACT

A driving method and a driving device for a display panel and a display apparatus are disclosed. The driving method includes: grouping every 2N rows of subpixels in the display panel as a subpixel group, grouping odd-numbered rows of subpixels in the subpixel group as a first subpixel group, and grouping even-numbered rows of subpixels in the subpixel group as a second subpixel group; for the subpixel group composed of 2N rows of subpixels, first driving pixels in the first sub group for display, and then driving subpixels in the second subpixel group for display. The display panel includes a plurality of pixel units arranged in an array. Each pixel unit includes subpixels of at least three colors. The subpixel of each color includes a first-type subpixel and a second-type subpixel.

### TECHNICAL FIELD

The present disclosure relates to a driving method and a driving device for a display panel and a display apparatus.

### BACKGROUND

With the development of liquid crystal display panels, large viewing angles and low costs have become important indicators of liquid crystal display panels. In various technologies of reducing the costs of liquid crystal display panels, tri-gate technology has been widely used for its faster data transmission speed. The tri-gate technique reduces a charging time of the pixel electrode to ⅓ of the original charging time, and accordingly, an operating frequency of a driving circuit that provides a data signal becomes three times the original.

In order to achieve the wide viewing angle for the liquid crystal display panel, gamma correction is employed for processing pixel units in the liquid crystal display panel. After the gamma correction, a level of the data signal on a subpixel of the liquid crystal display panel is different from that of adjacent subpixels in magnitude in a column direction and a row direction of the pixel unit arrangement, such that a rotation direction of the liquid crystal molecule corresponding to each subpixel is different from the rotation directions of the liquid crystal molecules corresponding to adjacent subpixels in the column direction and the row direction of the pixel unit arrangement. The liquid crystal molecules arranged in different directions in the liquid crystal display panel produce an effect similar to a diffuse reflection and increases the viewing angle when the liquid crystal display panel is viewed, and the liquid crystal display panel achieves the wide viewing angle accordingly.

When the low-cost tri-gate technique is combined with the gamma correction technique that achieves a wide viewing angle, the tri-gate technique itself has increased the operating frequency of the driving circuit, and after the gamma correction, the level of the data signal on the subpixel is different from that of adjacent subpixels in magnitude. As a result, a jump frequency of the level of the data signal provided by the driving circuit is greatly increased, thus the power consumption of the driving circuit for supplying the data signal is increased, and in a severe case, the driving circuit may even burn down.

### SUMMARY

In view of the above, embodiments of the present disclosure provide a driving method and a driving device for a display panel and a display apparatus, not only reducing the cost of the liquid crystal panel using the tri-gate technique, but also reducing the operating frequency of the driving circuit for supplying data signals compared with the related art, thereby reducing the power consumption of the driving circuit and reducing the risk of burning the driving circuit.

According to a first aspect, an embodiment of the present disclosure provides a driving method for a display panel including: grouping every 2N rows of subpixels of the display panel as a subpixel group, grouping odd-numbered rows of subpixels in the subpixel group as a first subpixel group, and grouping even-numbered rows of subpixels in the subpixel group as a second subpixel group, where N is an integer greater than 1; and for the subpixel group composed of 2N rows of subpixels, first driving subpixels in the first subpixel group for display, and then driving subpixels in the second subpixel group for display, or for the subpixel group composed of 2N rows of subpixels, first driving subpixels in the second subpixel group for display, and then driving subpixels in the first subpixel group for display.

The display panel comprises a plurality of pixel units arranged in an array.

Each of the plurality of pixel units comprises subpixels of at least three colors, and the subpixel of each color includes first-type subpixels and second-type subpixels.

The first-type subpixels and the second-type subpixels are alternatively arranged in both a row direction and a column direction of the pixel unit arrangement. A level of a data signal supplied by the driving circuit to the first-type subpixel is different from that of a data signal supplied by the driving circuit to the second-type subpixel.

Optionally, when a row of subpixels are driven for display, a scanning signal is supplied via a scanning line corresponding to the row of subpixels and the data signal is supplied via a data line corresponding to the row of subpixels; a changing period of a level of the data signal on each data line is 2N times a duration of the scanning signal; and subpixels in each row correspond to the same scanning line and subpixels in each column correspond to the same data line.

Optionally, each pixel unit of the display panel comprises a red subpixel, a green subpixel and a blue subpixel in the column direction of the pixel unit arrangement; and the first-type subpixel and the second-type subpixel in the subpixel of each color are arranged adjacent to each other in the row direction of the pixel arrangement.

Optionally, each subpixel group comprises six rows of subpixels or twelve rows of subpixels, and subpixels in the same row are of the same color.

Optionally, when subpixels in the first subpixel group are driven for display, blue subpixels in the first subpixel group are first driven for display; and when subpixels in the second subpixel group are driven for display, blue subpixels in the second sub group are first driven for display.

According to a second aspect, an embodiment of the present disclosure further provides a driving device for a display panel including: a display panel, wherein the display panel includes a plurality of pixel units, each of the plurality of pixel units includes subpixels of at least three colors, the subpixel of each color includes a first-type subpixel and a second-type subpixel, the first-type subpixel and the second-type subpixel are alternatively arranged in a row direction and a column direction of the pixel unit arrangement, every 2N rows of subpixels are grouped as a subpixel group, odd-numbered rows of subpixels in the subpixel group are grouped as a first subpixel group, even-numbered rows of subpixels in the subpixel group are grouped as a second subpixel group, and n is an integer greater than 1; and a driving circuit, wherein for the subpixel group composed of 2N rows of subpixels, the driving circuit is configured to: first drive one of the first subpixel group and the second subpixel group, and then drive the other one of the first subpixel group and the second subpixel group, and a level of a data signal supplied by the driving circuit to the first-type subpixel is different from that of a data signal supplied by the driving circuit to the second-type subpixel.

Optionally, the display panel comprises a plurality of scanning lines and a plurality of data lines, subpixels in each row correspond to the same scanning line, and subpixels in each column correspond to the same data line; when the row of subpixels are driven for display, the driving circuit is configured to supply a scanning signal via the scanning line corresponding to the row of subpixels, and supply the data signal via the data line corresponding to the row of subpixels; and a changing period of the level of the data signal on each data line is 2N times a duration of the scanning signal.

Optionally, each subpixel group comprises six rows of subpixels or twelve rows of subpixels, and subpixels in the same row are of the same color.

Optionally, the driving circuit is further configured to: first drive blue subpixels in the first subpixel group for display during driving subpixels in the first subpixel group for display; and first drive blue subpixels in the second sub group for display during driving subpixels in the second subpixel group for display.

According to a third aspect, the present disclosure further provides a PVA liquid crystal display panel, including: 3N gate lines extending in a first direction; 2M data lines extending in a second direction, wherein the first direction is substantially perpendicular to the second direction; and a plurality of pixel units arranged in N rows and M columns, wherein each of the plurality of pixel units comprises a red subpixel, a green subpixel and a blue subpixel which are sequentially arranged in the second direction, each of the red subpixel, the green subpixel and the blue subpixel comprises a high-gray region and a low-gray region arranged in the first direction, and each of the red subpixel, the green subpixel and the blue subpixel is coupled to one corresponding gate line and two corresponding data lines, where M is an integer greater than 1 and N is an even integer greater than 2.

The plurality of pixel units are configured such that adjacent regions of each high-gray region are all low-gray regions and adjacent regions of each low-gray region are all high-gray regions.

The red subpixel, the green subpixel and the blue subpixel are arranged in a subpixel array in 3N rows. Each row of the subpixel array is composed of subpixels of same color.

The high-gray region is ahead of the low-gray region in a starting subpixel in each odd-numbered row of subpixel array, and the low-gray region is ahead of the high-gray region in a starting subpixel in each even-numbered row of subpixel array; or the low-gray region is ahead of the high-gray region in a starting subpixel in each odd-numbered row of subpixel array, and the high-gray region is ahead of the low-gray region in a starting subpixel in each even-numbered row of subpixel array.

Embodiments of the present disclosure provide a driving method and a driving device for a display panel and a display apparatus. Every 2N rows of subpixels in the display panel are grouped as the subpixel group, the odd-numbered rows of subpixels in the subpixel group are arranged as the first subpixel group, and the even-numbered rows of subpixels in the subpixel group are arranged as the second subpixel group, where n is an integer greater than 1. For the subpixel group composed of 2N rows of subpixels, the subpixels in the first subpixel group are first driven for display, and then the subpixels in the second subpixel group are driven for display; or, the subpixels in the second subpixel group are first driven for display, and then the subpixels in the first subpixel group are driven for display. The display panel is arranged to include a plurality of pixel units arranged in an array, and each pixel unit includes subpixels of at least three colors. The subpixel of each color includes the first-type subpixel and the second-type subpixel. The first-type subpixels and the second-type subpixels are alternatively arranged in the row direction and the column direction of the pixel unit arrangement. A level of the data signal of the first-type subpixel supplied by the driving circuit is arranged to be different from that of the data signal of the second-type subpixel supplied by the driving circuit. That is, the odd-numbered rows of subpixels are first driven for display and then the even-numbered rows of subpixels are driven for display; or the even-numbered rows of subpixels are first driven for display and then the odd-numbered rows of subpixels are driven for display. At least two rows of subpixels, the levels of the data signals of which are the same, are simultaneously driven. The jump frequency of the level of the data signal supplied by the driving circuit is reduced. The cost of the liquid crystal panel is reduced by the tri-gate technique. The operating frequency of the driving circuit for supplying data signals is reduced compared with the related art, thereby the power consumption of the driving circuit is reduced and the risk of burning the driving circuit is reduced.

### BRIEF DESCRIPTION OF DRAWINGS

In order to more clearly illustrate technical solutions of embodiments of the present disclosure or the related art, accompanying drawings, which are to be used in the description of the embodiments or the related art, are briefly described below. It will be apparent that the accompanying drawings described below are some of the embodiments of the present disclosure, and other accompanying drawings may be obtained according to these accompanying drawings by those skilled in the art without creative work.

FIG. 1 is a schematic flowchart of a driving method for a display panel according to an embodiment of the present disclosure;

FIG. 2 is a schematic diagram illustrating an arrangement order of subpixels of a display panel according to an embodiment of the present disclosure;

FIG. 3 is a driving timing sequence diagram of the display panel shown in FIG. 2;

FIG. 4 is a schematic flowchart of another driving method for a display panel according to an embodiment of the present disclosure;

FIG. 5 is another driving timing sequence diagram of the display panel shown in FIG. 2;

FIG. 6 is a schematic structure diagram of a driving device of a display panel according to an embodiment of the present disclosure;

FIG. 7 is a schematic structure diagram of a display apparatus according to an embodiment of the present disclosure; and

FIG. 8 is a schematic structure diagram of a PVA liquid crystal display panel according to an embodiment of the present disclosure.

### DETAILED DESCRIPTION

In order to make the purpose, the technical solutions and advantages of the present disclosure more clear, the technical solutions of the present disclosure will be described clearly and completely by means of embodiments with reference to the accompanying drawings in the embodiments of the present disclosure. Apparently, the described embodiments are part of embodiments of the present disclosure and not all embodiments. Other embodiments obtained by those skilled in the art based on the embodiments of the present disclosure without creative work are within the scope of the present disclosure. It is also to be noted that, for the sake of convenience of description, only parts which are related to the present disclosure and not all structures are shown in the accompanying drawings. Throughout the specification, like or similar reference numerals refer to like or similar structures, elements, or processes. It is to be noted that, if not in conflict, embodiments and the features in the embodiments in the present disclosure may be combined with each other.

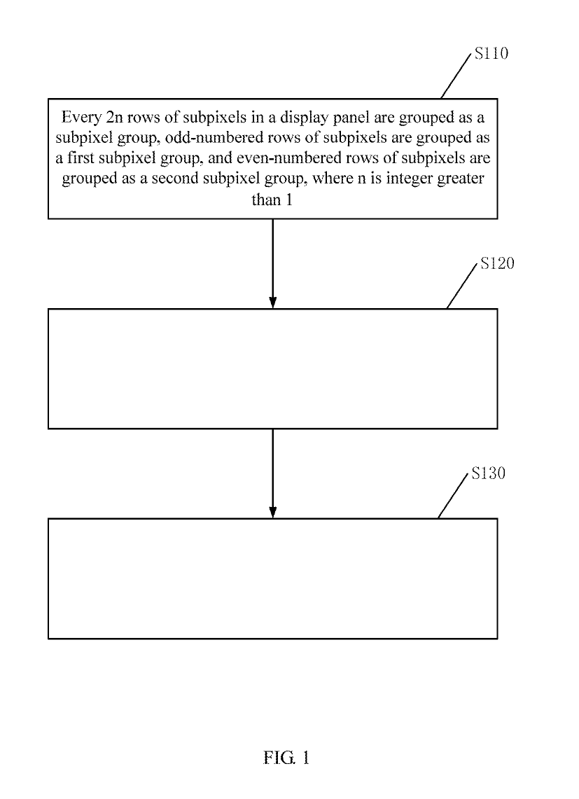

FIG. 1 is a schematic flowchart of a driving method for a display panel according to an embodiment of the present disclosure. The technical solution in the present embodiment can be carried out by a driving device provided by an embodiment of the present disclosure. The method includes steps S110 to S130.

In step S110, every 2N rows of subpixels in the display panel are grouped as a subpixel group, odd-numbered rows of subpixels in the subpixel group are grouped as a first subpixel group and even-numbered rows of subpixels in the subpixel group are grouped as a second subpixel group, where n is an integer greater than 1.

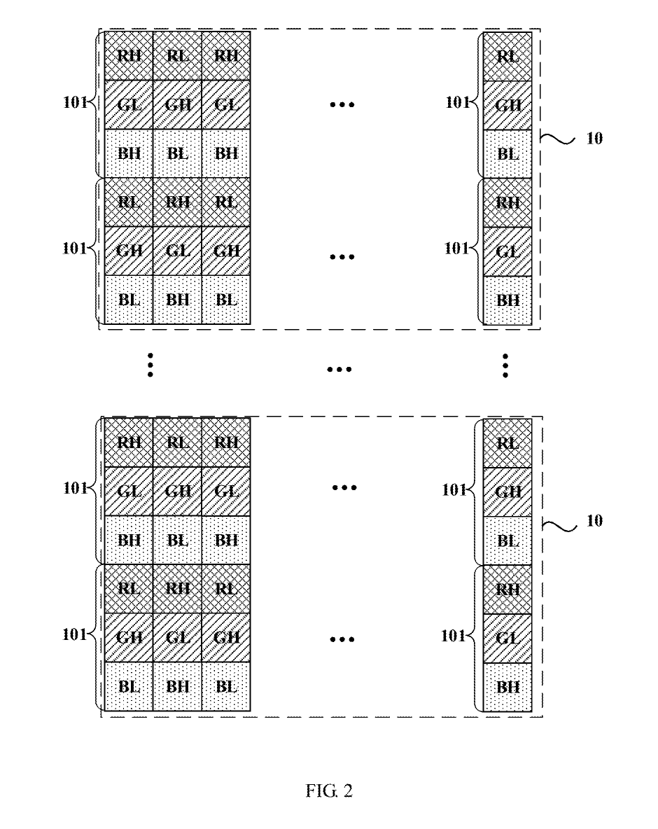

FIG. 2 is a schematic diagram illustrating an arrangement order of subpixels of the display panel according to an embodiment of the present disclosure. As shown in FIG. 2, the display panel includes a pixel array composed of pixels 101 which are arranged in rows and columns. Each pixel 101 includes subpixels of at least three colors. Subpixels of each color include a first-type subpixel and a second-type subpixel. The first-type subpixel and the second-type subpixel are alternatively arranged in a row direction and a column direction of the pixel array. A level of a data signal supplied by a driving circuit to the first-type subpixel is different form that of a data signal supplied by the driving circuit to the second-type subpixel in magnitude.

With reference to FIG. 2, exemplarily, each pixel 101 in the display panel includes a red subpixel R, a green subpixel G and a blue subpixel B arranged in the column direction of the pixel array. The first-type subpixel and the second-type subpixel in the subpixel of each other are arranged adjacent to each other in the row direction of the pixel array. That is, the red subpixel R includes a first-type subpixel RH and a second-type subpixel RL, the green subpixel G includes a first-type subpixel GH and a second-type subpixel GL, and the blue subpixel B includes a first-type subpixel BH and a second-type subpixel BL. The first-type subpixel RH and the second-type subpixel RL, the first-type subpixel GH and the second-type subpixel GL, and the first-type subpixel BH and the second-type subpixel BL are arranged adjacent to each other in the row direction of the pixel array, respectively. Exemplarily, the levels of the data signals supplied by the driving circuit of the first-type subpixels RH, GH and BH are high, and the levels of the data signals supplied by the driving circuit of the second-type subpixels RL, GL and BL are low. Herein, the high and low of the level may be relative to each other, that is, the level of the data signal of the first-type subpixel supplied by the driving circuit is higher than the level of the data signal of the second-type subpixel supplied by the driving circuit. The first-type subpixels and the second-type subpixels are alternatively arranged in the row direction and the column direction of the pixel array. Exemplarily, as shown in FIG. 2, subpixels RH, GL, BH, RL, GH and BL are sequentially arranged in the column direction of the pixel array. Subpixels RH and RL, subpixels GH and GL, and subpixels BH and BL are arranged adjacent to each other, respectively.

It is to be noted that FIG. 2 just has an exemplary configuration in which each pixel 101 includes subpixels of three colors. The quantity of the subpixels in each pixel 101 is not limited and the arrangement order of the colors of the subpixels in each pixel 101 is not limited, as long as each pixel 101 includes subpixels of at least three colors. Herein, the arrangement order of the subpixels in each pixel 101 being RGB is taken as an example. The arrangement order of the subpixels in each pixel 101 of the pixel may be any one of RGB, RBG, GBR, GRB, BRG and BGR. Meanwhile, it is just exemplarily arranged in FIG. 2 that the levels of the data signals of the first-type subpixels RH, GH and BH supplied by the driving circuit are high, and the levels of the data signals of the second-type subpixels RL, GL and BL supplied by the driving circuit are low. It also may be arranged that the levels of the data signals of the first-type subpixels RH, GH and BH supplied by the driving circuit are low, and the levels of the data signals of the second-type subpixels RL, GL and BL supplied by the driving circuit are high, which is not limited in embodiments of the present disclosure.

For convenience of description, in the following embodiment, the configuration in which the arrangement order of the subpixels in each pixel 101 is RGB, the levels of the data signals of the first-type subpixels RH, GH and BH supplied by the driving circuit are high, and the levels of the data signals of the second-type subpixels RL, GL and BL supplied by the driving circuit are low, and the first subpixel in each pixel group 10 is the first-type subpixel RH is taken as an example for description. As shown in FIG. 2, every 2N rows of subpixels of the display panel are grouped as the subpixel group 10, odd-numbered rows of subpixels in the subpixel group 10 are grouped as the first subpixel group and even-numbered rows of subpixels in the subpixel group 10 are grouped as the second subpixel group, where n is an integer greater than 1. Optionally, n may be any positive integer greater than 1, each subpixel group 10 includes six rows of subpixels, or includes twelve rows of subpixels, the subpixels in the same row may be of the same color or may be of different colors. The value of n is not limited, and whether the colors of the subpixels in the same row are identical is not limited in embodiments of the present disclosure. For convenience of description, in the following embodiment, the configuration in which each subpixel group 10 includes six rows of subpixels and the colors of subpixels in the same row are the same is taken as an example for description. As shown in FIG. 2, in each pixel group 10, the first subpixel group includes the first row of subpixels, the third row of subpixels and the fifth row of subpixels, and the second subpixel group includes the second row of subpixels, the fourth row of subpixels and the sixth row of subpixels.

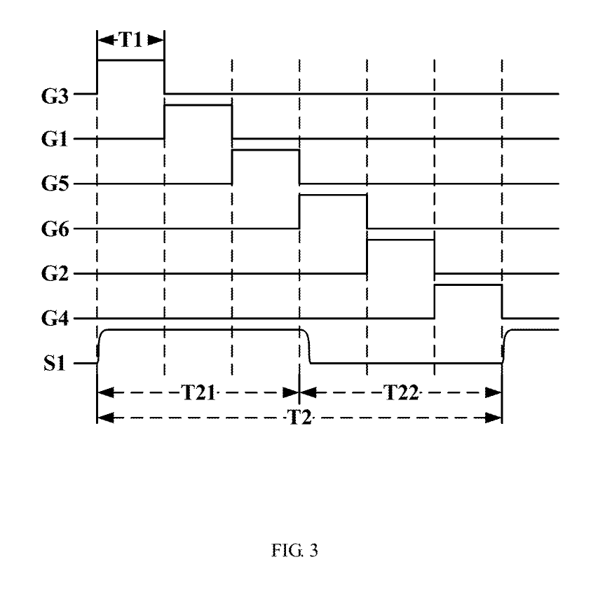

Optionally, when driving a row of subpixels for display, a scanning signal is provided via a scanning line corresponding to the row of subpixels, and data signals are provided via data lines corresponding to the row of subpixels. Subpixels of each row correspond to the same scanning line, and subpixels of each column correspond to the same data line. FIG. 3 is a driving timing sequence diagram of the display panel shown in FIG. 2, G1 to G6 are the six scanning signals corresponding to the six rows of subpixels in one subpixel group 10, respectively. FIG. 3 exemplarily illustrates a variation law of the data signal S1 corresponding to the first column of the subpixel group 10 along with G1 to G6, the variation frequencies of data signals corresponding to other columns of subpixels are the same as those of the data signal S1 corresponding to the first column of subpixels. Each scanning signal can supply a trigger signal for each row of subpixels. In FIG. 3, it is exemplarily arranged that the scanning signals input high level signals which hold for a period T1 according to a certain order. Alternatively, the scanning signals may be low level signals. Herein, the configuration in which the scanning signal serving as the trigger signals is a high level signal is taken as an example. When the data signal corresponding to a certain row of subpixels in the subpixel group 10 is at high level, display is enabled for this row of subpixels, and the data lines corresponding to this row of subpixels supply data signals to the subpixels in this row.

In step S120, for each subpixel group composed of 2N rows of subpixels, the subpixels in the first subpixel group are driven for display.

During display, with respect to the arrangement order of the subpixels of the display panel shown in FIG. 2, for the subpixel group composed of 2N rows of subpixels, subpixels of the first subpixel group are first driven for display, that is, odd-numbered rows of subpixels are driven for display, where n is an integer greater than 1 and is exemplarily set to 3. As shown in FIG. 3, the odd-numbered rows of subpixels are first driven for display, that is, the first row, the third row and the fifth row of subpixels are first driven for display. Exemplarily, the subpixels of the first row, the third row and the fifth row among subpixels in each column are the first-type subpixels, that is, the levels of the data signals of the subpixels in the odd-numbered rows supplied by the driving circuit are at high level. Taking the first column of subpixels in the subpixels as an example, as shown in FIG. 3, in a first stage T21 for driving the odd-numbered rows of subpixels in the subpixel group 10, the levels of data signals S1 on the data line corresponding to the subpixels in odd-numbered rows in the first column are high and do not jump because the subpixels of the first row, the third row and the fifth row among subpixels in each column are the first-type subpixels and the levels of the data signals of the first-type subpixels supplied by the driving circuit are high. In contrast, according to the driving method for the display panel provided by the related art, when driving the same three rows of subpixels for display, the levels of the data signals on the data line corresponding to each column of subpixels will jump twice. The driving method according to embodiments of the present disclosure reduces the jump frequency of the levels of data signals, thereby reducing the power consumption of the driving circuit.

In step S130, the subpixels of the second subpixel group are driven for display.

During display, the subpixels of the second subpixel group of the subpixel group 10 are driven for display, that is, the even-numbered rows of subpixels are driven for display. As shown in FIG. 3, in a second stage T22, the even-numbered rows of subpixels of the subpixel group 10 are driven for display, that is, the second row of subpixels, the fourth row of subpixels and the sixth row of subpixels are driven for display. Exemplarily, the subpixels of the second row, the fourth row and the sixth row among the subpixels of each column are the second-type subpixels, that is, the levels of the data signals of the subpixels in even-numbered rows supplied by the driving circuit are low. Taking the first column of subpixels among the subpixels for an example, as shown in FIG. 3, in the second stage T22 for driving the even-numbered rows of subpixels of the subpixel group 10 for display, the subpixels at the second row, the fourth row and sixth row in each column are the second-type subpixels and the levels of the data signals of the second-type subpixels supplied by the driving circuit are low. Therefore, the levels of the data signals S1 on the data line corresponding to the subpixels in the even-numbered rows in the first row are low and do not jump. Likewise, according to the driving method for the display panel provided by the related art, when driving the same three rows of subpixels for display, the levels of the data signals on the data line corresponding to each column of subpixels will jump twice. The driving method according to embodiments of the present disclosure reduces the jump frequency of the level of data signal, thereby reducing the power consumption of the driving circuit.

Optionally, as shown in FIG. 3, the duration of each scanning signal is T1, the subpixels in the display panel are driven in the order in which the odd-numbered rows of subpixels in the subpixel group 10 composed of 2N rows of subpixels are first driven and then the even-numbered rows of subpixels are driven, such that a changing period of the level of the data signal on each data line is T2, and T2 is 2N times of T1. Taking N=3 for an example, as shown in FIG. 3, T2 is six times of T1. Not only the cost of the liquid crystal panel is reduced using the tri-gate technique, the operating frequency of the driving circuit for supplying data signals is also reduced compared with the related art, thereby reducing the power consumption of the driving circuit and reducing the risk of burning the driving circuit.

Optionally, FIG. 3 exemplarily shows the driving timing sequence of the display panel. In FIG. 3, the first subpixel group of the subpixel group 10 is first driven (that is, the odd-numbered rows of subpixels are driven for display), and then the second subpixel group of the subpixel group 10 is driven (that is, the even-numbered rows of subpixels are driven for display); and the blue subpixels B among the even-numbered rows of subpixels may be first driven when the second subpixel group is driven, that is, when the even-numbered rows of subpixels are driven for display. FIG. 3 exemplarily shows that when the even-numbered rows (that is, the second, fourth and sixth rows) of subpixels are driven for display, the blue subpixels B among the even-numbered rows of subpixels are first driven, that is, the blue subpixels B in the sixth row of the subpixel group 10 are first driven for display. In this way, when the levels of the data signals S1 are changed from high to low, the jump positions of the levels are at the blue subpixels B. Compared with red and green, blue is least possible to be sensed by the human eye. Therefore, an influence of the jump of the levels of the data signals on the display effect of the display panel can be minimized when the jump positions of the levels of the data signals are disposed at the blue subpixels B.

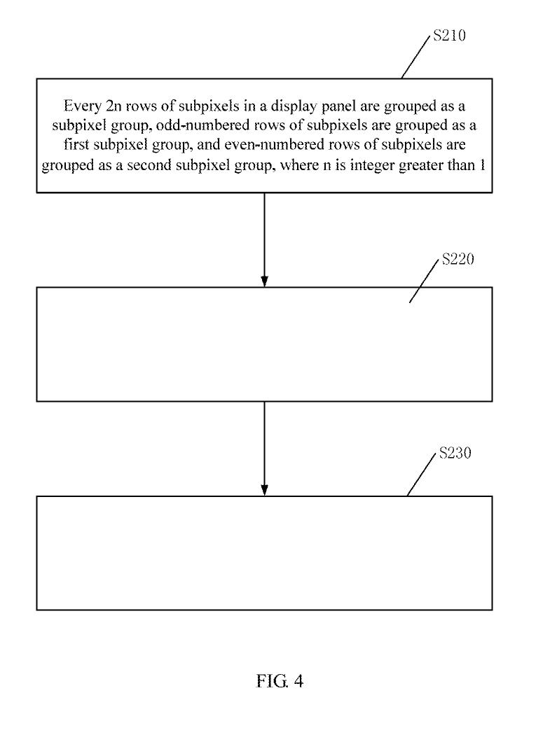

It is to be noted that, in the above embodiments, for the subpixel group 10 composed of 2N rows of subpixels, the first subpixel group is first driven, that is, the odd-numbered rows of subpixels are driven for display; and then the second subpixel group is driven, that is, the even-numbered rows of subpixels are driven for display. Alternatively, the second subpixel group may be first driven, that is, the even-numbered rows of subpixels are driven for display; and then the first subpixel group is driven, that is, the odd-numbered rows of subpixels are driven for display. FIG. 4 is a schematic flowchart of another driving method for a display panel according to an embodiment of the present disclosure. The method includes steps S210 to S230.

In step S210, every 2N rows of subpixels in the display panel are arranged as a subpixel group, odd-numbered rows of subpixels in the subpixel group are arranged as a first subpixel group, and even-numbered rows of subpixels in the subpixel group are arranged as a second subpixel group, where n is an integer greater than 1.

In step S220, for the subpixel group composed of 2N rows of subpixels, the subpixels in the second subpixel group are driven for display.

In step S230, the subpixels in the first subpixel group are driven for display.

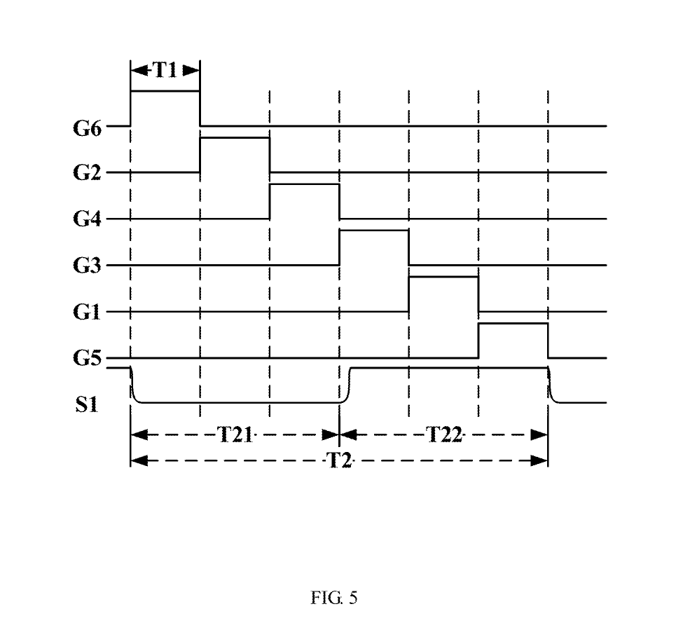

Corresponding to the driving method for the display panel shown in FIG. 4, the driving timing sequence diagram of the display panel shown in FIG. 2 is illustrated in FIG. 5. The data signal S1 is changed from the low level in the first stage T21 to the high level in the second stage T22, and a changing period T2 of the level of the data signal on the data line is 2N times the duration T1 of scanning signal. Taking n=3 for an example, as shown in FIG. 5, T2 is six times T1. Similarly, the jump frequency of the level of the data signal is reduced and the power consumption of the driving circuit is reduced.

Optionally, FIG. 5 shows the driving timing sequence of the display panel. In FIG. 5, the second subpixel group of the subpixel group 10 is first driven (that is, the even-numbered rows of subpixels are driven for display), and then the first subpixel group of the subpixel group 10 is driven (that is, the odd-numbered rows of subpixels are driven for display); and when the odd-numbered rows of subpixels are driven for display, the blue subpixels B among the odd-numbered rows of subpixels, that is, the blue subpixels B in the third row are first driven for display. Similarly, the jump positions of the levels of the data signals are arranged at the blue subpixels B, thereby relieving the influence of the jump of the levels of the data signals on the display effect of the display panel.

It is to be noted that, with respect to driving the odd-numbered rows of subpixels in the subpixel group 10 for display, FIG. 3 and FIG. 5 just exemplarily illustrate that the driving is carried out in the order of the third row, the first row and the fifth row; with respect to driving the even-numbered rows of subpixels in the subpixel group 10 for display, FIG. 3 and FIG. 5 just exemplarily illustrate that the driving is carried out in the order of the sixth row, the second row and the fourth row. The odd-numbered rows of subpixels and the even-numbered rows of subpixels in the subpixel group 10 may be driven in other driving orders, which is not limited in embodiments of the present disclosure.

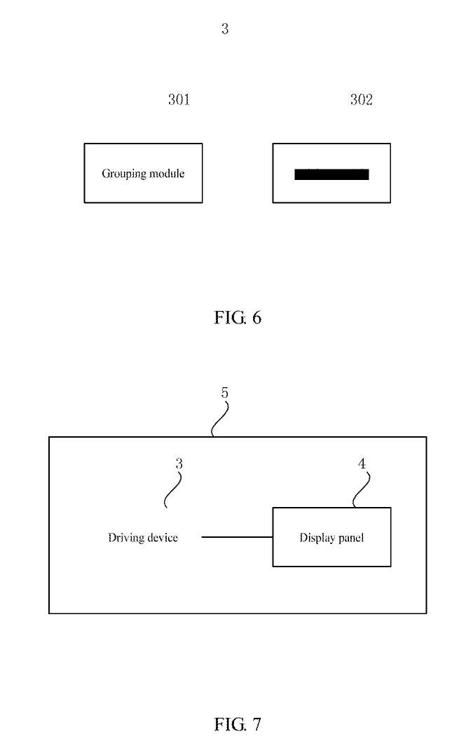

FIG. 6 is a schematic structure diagram of a driving device of a display panel according to an embodiment of the present disclosure. The driving device 3 includes a grouping module 301 and a driving circuit 302.

The grouping module 301 is configured to arrange every 2N rows of subpixels in the display panel as a subpixel group, to arrange odd-numbered rows of subpixels in the subpixel group as a first subpixel group, and to arrange the even-numbered rows of subpixels in the subpixel group as a second subpixel group, where n is an integer greater than 1.

For the subpixel group composed of 2N rows of subpixels, the driving circuit 302 is configured to first drive the subpixels in the first subpixel group for display and then drive the subpixels in the second subpixel group for display. Alternatively, the driving circuit 302 is configured to first drive the subpixels in the second subpixel group for display and then drive the subpixels in the first subpixel group for display.

The display panel includes a plurality of pixel units arranged in an array. Each pixel includes subpixels of at least three colors. Subpixels of each color include a first-type subpixel and a second-type subpixel. The first-type subpixels and the second-type subpixels are alternatively arranged in a row direction and a column direction of the pixel array. A level of a data signal of the first-type subpixel supplied by the driving circuit is different from that of a data signal of the second-type subpixel supplied by the driving circuit. Exemplarily, the display panel in the present embodiment is, for example, a liquid crystal display panel.

Optionally, the display panel includes a plurality of scanning lines and a plurality of data lines. Each row of subpixels corresponds to the same scanning line, and each column of subpixels corresponds to the same data line. When driving one row of subpixels for display, the driving circuit 302 may supply a scanning signal via the scanning line corresponding to the row of the subpixels, and supply data signals via the data lines corresponding to the row of subpixels. A changing period of the level of the data signal on each data line is 2N times a duration of the scanning signal.

Exemplarily, the driving circuit 302 may include a data driving circuit, a gate driving circuit and a controller. The data driving circuit may supply data signals to the subpixels. The gate driving circuit may supply scanning signals to the subpixels. The controller is used to control the data driving circuit and the gate driving circuit. The driving circuit 302 further includes a gamma voltage generator. The gamma voltage generator is configured to selectively supply a first gamma voltage and a second gamma low voltage to the data driving circuit, and the first gamma voltage is greater than the second gamma voltage.

The controller receives external synchronizing signal and clock signal to generate a first control signal for controlling the gate driving circuit and a second control signal for controlling the data driving circuit. The controller is, for example, a general purpose processor, a digital signal processor (DSP), an application specific integrated circuit (ASIC), or a field programmable gate array (FPGA), etc. The gate driving circuit sequentially drives the plurality of gate lines of the display panel in response to the first control signal received from the controller. The controller also supplies an initial data signal to the data driving circuit. Optionally, the initial data signal is a digital signal.

The data driving circuit receives the initial data signal, the second control signal, and the first gamma voltage and the second gamma voltage. The data driving circuit generates a first data signal based on the initial data signal and the first gamma signal, and generates a second data signal based on the initial data signal and the second gamma voltage. The data driving circuit further supplies the first data signal to the first-type sub-pixel and supplies the second data signal to the second-type sub-pixel. Alternatively, the data driving circuit includes a digital-to-analog conversion circuit, an amplifier, a switching circuit, and the like.

Optionally, the gamma voltage generator includes a cascaded resistor string.

Optionally, in the column direction of the pixel array, each pixel of the display panel may include a red subpixel R, a green subpixel G and a blue subpixel B. The first-type subpixel and the second-type subpixel of the subpixel of each color are arranged adjacent to each other in the row direction of the pixel array.

Optionally, each subpixel group of the display panel may include six rows of subpixels or twelve rows of subpixels, and the subpixels in the same row are of the same color.

Optionally, when the subpixels in the first subpixel group are driven for display, the blue subpixels in the first subpixel group are first driven. When the subpixels in the second subpixel group are driven for display, the blue subpixels in the second subpixel group are first driven.

According to embodiments of the present disclosure, every 2N rows of subpixels in the display panel are grouped as a subpixel group, the odd-numbered rows of subpixels in the subpixel group are arranged as the first subpixel group, and the even-numbered rows of subpixels in the subpixel group are arranged as the second subpixel group, where n is an integer greater than 1. For the subpixel group composed of 2N rows of subpixels, the subpixels in the first subpixel group are first driven for display, and then the subpixels in the second subpixel group are driven for display; or, the subpixels in the second subpixel group are first driven for display, and then the subpixels in the first subpixel group are driven for display. The display panel is arranged to include a plurality of pixel units arranged in an array, and each pixel unit includes subpixels of at least three colors. The subpixel of each color includes the first-type subpixel and the second-type subpixel. The first-type subpixels and the second-type subpixels are alternatively arranged in the row direction and the column direction of the pixel unit arrangement. A level of the data signal of the first-type subpixel supplied by the driving circuit is arranged to be different from that of the data signal of the second-type subpixel supplied by the driving circuit. That is, the odd-numbered rows of subpixels are first driven for display and then the even-numbered rows of subpixels are driven for display; or the even-numbered rows of subpixels are first driven for display and then the odd-numbered rows of subpixels are driven for display. It is achieved that at least two rows of subpixels, the levels of the data signals of which are the same, are simultaneously driven. The jump frequency of the level of the data signal supplied by the driving circuit is reduced. Not only the cost of the liquid crystal panel is reduced using the tri-gate technique, the operating frequency of the driving circuit for supplying data signals is also reduced compared with the related art, and thereby the power consumption of the driving circuit is reduced and the risk of burning the driving circuit is reduced.

An embodiment of the present disclosure further provides a display apparatus. FIG. 7 is a schematic structure diagram of a display apparatus according to an embodiment of the present disclosure. As shown in FIG. 7, a display apparatus 5 includes a display panel 4 and a driving device 3 which are described in the above embodiments. Therefore, the display apparatus provided in the present embodiment also has the beneficial effects described in the above embodiments, and will not be described here. Exemplarily, the display apparatus provided by the present disclosure may be a mobile phone, a computer, or the like, and is not limited in the present disclosure.

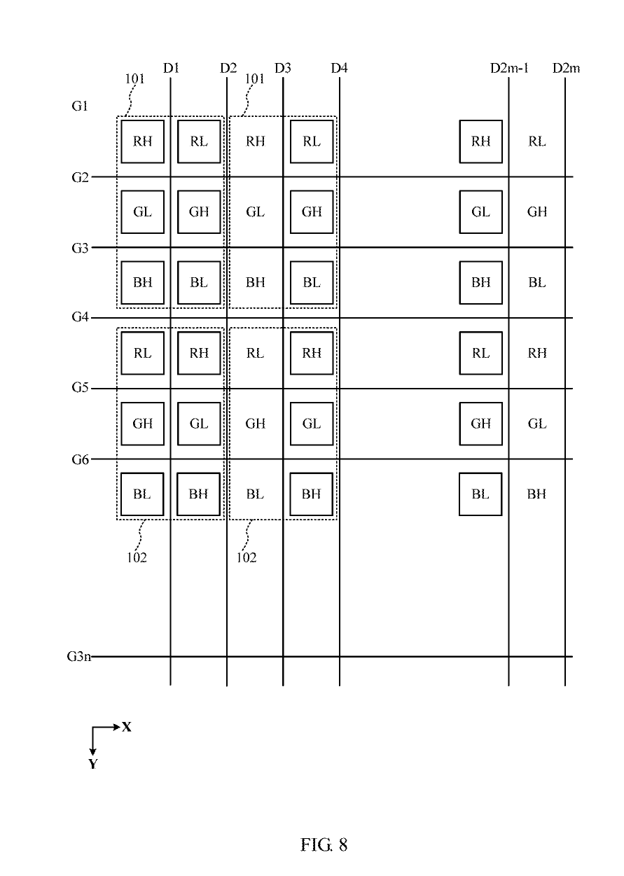

As shown in FIG. 8, the present disclosure further provides a Patterned Vertical Alignment Liquid Crystal Display Panel (PVALCD) and a driving method thereof. The PVA liquid crystal display panel in the present embodiment includes: gate lines G1 to G3n extending in a first direction X, data lines D1 to D2m extending in a second direction Y and a plurality of pixel units arranged in an array. The first direction X is substantially perpendicular to the second direction Y. In the present embodiment, the plurality of pixel units are arranged in an array of n rows and m columns.

Each pixel unit includes a red subpixel, a green subpixel and a blue subpixel which are arranged in the second direction Y. These subpixels are arranged in 3N rows. Each of the red subpixel, the green subpixel and the blue subpixel includes a high-gray region and a low-gray region which are arranged in the first direction. The high-gray region is driven based on a first gamma curve and the low-gray region is driven based on a second gamma curve.

In the present embodiment, the red subpixel includes a first red subpixel RH (high-gray region) and a second red subpixel RL (low-gray region), the green subpixel includes a first green subpixel GH (high-gray region) and a second green subpixel GL (low-gray region), and the blue subpixel includes a first blue subpixel BH (high-gray region) and a second blue subpixel BL (low-gray region).

Each pixel unit is coupled to three gate lines and two data lines. Each of the first red subpixel RH, the second red subpixel RL, the first green subpixel GH, the second green subpixel GL, the first blue subpixel BH and the second blue subpixel BL includes a thin film transistor, a gate electrode of the thin film transistor is coupled to a corresponding gate line, and a drain electrode is coupled to a corresponding data line.

The plurality of pixel units include multiple first pixel units 101 and multiple second pixel units 102. The plurality of pixel units arranged in an array include rows composed of the first pixel units 101 and rows composed of the second pixel units 102. The rows composed of the first pixel units 101 and the rows composed of the second pixel units 102 are alternatively arranged. As shown in FIG. 8, in the present embodiment, the odd-numbered rows of the plurality of pixel units include multiple first pixel units 101 and the even-numbered rows of the plurality of pixel units include multiple second pixel units 102.

As shown in FIG. 8, in the present embodiment, the first red subpixel RH and the second red subpixel RL in the first pixel unit 101 are sequentially arranged in the first direction; the second green subpixel GL and the first green subpixel GH in the first pixel unit 101 are sequentially arranged in the first direction; and the first blue subpixel BH and the second blue subpixel BL in the first pixel unit 101 are sequentially arranged in the first direction. The second red subpixel RL and the first red subpixel RH in the second pixel unit 102 are sequentially arranged in the first direction; the first green subpixel GH and the second green subpixel GL in the second pixel unit 102 are sequentially arranged in the first direction; and the second blue subpixel BL and the first blue sun pixel BH in the second pixel unit 102 are sequentially arranged in the first direction. In this way, the adjacent regions of the high-gray region are low-gray regions, and the adjacent regions of the low-gray region are high-gray regions.

When the PVD liquid crystal display panel in the present embodiment is driven, the plurality of pixel units which are arranged in an array are divided into a plurality of driving groups. Each driving group includes multiple rows of pixel units, and the plurality of driving groups are sequentially driven.

For example, the first row and the second row of the plurality of pixel units are arranged as one group. The first row and the second row of the plurality of pixel units include six rows of subpixels. The six rows of subpixels correspond to gate lines G1 to G6. In the present embodiment, the first row of subpixels include multiple red subpixels; the second row of subpixels include multiple includes multiple green subpixels; the third row of subpixels include multiple blue subpixels; the fourth row of subpixels include multiple red subpixels; the fifth row of subpixels include multiple green subpixels; and the sixth row of subpixels include multiple blue subpixels.

First, the first row of subpixels, the second row of subpixels and the fifth row of subpixels are sequentially driven via the gate lines G1, G3 and G5. For example, a gate signal is supplied to the thin film transistors of subpixels in the first row via the gate line G1 such that the thin film transistors are turned on. Data signals for display are supplied to the subpixels in the first row via the data lines D1 to Dm. Herein, the data signals supplied to the high-gray regions are corrected according to the first gamma curve, and the data signals supplied to the low-gray regions are corrected according to the second gamma curve. For the same sub-pixel (the red subpixel, the green subpixel and the blue subpixel), the level of the data signal supplied to high-gray region is higher than the level of the data signal supplied to the low-gray region.

Then, the second row of subpixels, the fourth row of subpixels and the sixth row of subpixels are sequentially driven via the gate lines G2, G4 and G6.

In the present embodiment, when the first row of subpixels, the third row of subpixels and the fifth row of subpixels are driven, the data signal on each data line is corrected according to the same gamma curve. For example, when driving the first row of subpixels, the third row of subpixels and the fifth row of subpixels, the data signal supplied to the first red subpixel RH in the first pixel unit 101 via the data line D1, the data signal supplied to the first blue subpixel BH in the first pixel unit 101 via the first data line D1, and the data signal supplied to the first green subpixel GH in the second pixel unit 102 via the data line D1 are corrected based on the first gamma curve. When the second row of subpixels, the fourth row of subpixels and the sixth row of subpixels are driven, the data signal on each data line is also corrected based on the same gamma curve. For example, when the second row of subpixels, the fourth row of subpixels and the sixth row of subpixels are driven, the data signal supplied to the second green subpixel GL in the first pixel unit 101 via the data line D1, the data signal supplied to the second red subpixel RL in the second pixel unit 102 via the first data line D1, and the data signal supplied to the second blue subpixel BL in the second pixel unit 102 via the data line D1 are corrected based on the second gamma curve.

Optionally, when the first row of subpixels, the third row of subpixels and the fifth row of subpixels are sequentially driven, the third row of subpixels are driven last, that is, the row composed of blue subpixels is driven last.

Optionally, when the second row of subpixels, the fourth row of subpixels and the sixth row of subpixels are sequentially driven, the sixth row of subpixels are driven last.

In another embodiment, the second row of subpixels, the fourth row of subpixels and the sixth row of subpixels are first sequentially driven via the gate lines G2, G4 and G6, then the first row of subpixels, the third row of subpixels and the fifth row of subpixels are sequentially driven via the gate lines G1, G3 and G5.

In other embodiment, the first row to the fourth row of the plurality of pixel units are arranged as a group. The first row of pixel units to the fourth row of pixel units include twelve rows of subpixels, and these twelve rows of subpixels correspond to gate lines G1 to G12. First, the first row of subpixels, the third row of subpixels, . . . the eleventh row of subpixels are sequentially driven through the odd-numbered gate lines G1, G3, . . . G11; and then the second row of subpixels, the fourth row of subpixels, . . . the twelfth row of subpixels are sequentially driven through the even-numbered gate lines G2, G4, . . . G12.

It is noted that the foregoing is merely preferred embodiments of the present disclosure and the technical principles used therein. It will be understood by those skilled in the art that the present disclosure is not limited to the specific embodiments herein, and that those skilled in the art can make various changes, modifications and substitutions within the scope of the present disclosure. Accordingly, although the present disclosure has been described in more detail by way of the above embodiments, the present disclosure is not limited to the above embodiments, and other equivalent embodiments may be included without departing from the spirit of the present disclosure. The scope of the disclosure is determined by the appended claims.

What is claimed is:

1. A driving method for a display panel including subpixels, comprising:
grouping each 2N rows of the subpixels of the display panel as a subpixel group, grouping odd-numbered rows of the subpixels in the subpixel group as a first subpixel group, and grouping even-numbered rows of the subpixels in the subpixel group as a second subpixel group, wherein N is an integer greater than 1; and
for the subpixel group composed of 2N rows of the subpixels, first driving one of the first subpixel group and the second subpixel group for displaying, and then driving the other one of the first subpixel group and the second subpixel group for displaying,
wherein the display panel comprises a plurality of pixel units arranged in an array, each of the plurality of pixel units comprises subpixels of at least three colors, the subpixels of each color comprises first-type subpixels and second-type subpixels, and wherein the first-type subpixels and the second-type subpixels are alternatively arranged in both of a row direction and a column direction, and a level of a data signal supplied by a driving circuit to the first-type subpixels is different from that of a data signal supplied by the driving circuit to the second-type subpixels.

2. The driving method of claim 1, wherein
when a row of subpixels are driven for displaying, a scanning signal is supplied via a scanning line corresponding to the row of subpixels and the data signal is supplied via a data line corresponding to the row of subpixels;
a period of changing of the level of the data signal on each data line is 2N times of a duration of the scanning signal; and
wherein subpixels in each row correspond to a same scanning line, and subpixels in each column correspond to a same data line.

3. The driving method of claim 1, wherein each pixel unit of the display panel comprises a red subpixel, a green subpixel and a blue subpixel in the column direction of the pixel unit arrangement;
the first-type subpixels and the second-type subpixels in the subpixels of each color are arranged adjacent to each other in the row direction of the pixel units arrangement.

4. The driving method of claim 1, wherein each subpixel group comprises six rows of subpixels or twelve rows of subpixels, and subpixels in a same row are of a same color.

5. The driving method of claim 1, wherein when subpixels in the first subpixel group are driven for displaying, blue subpixels in the first subpixel group are first driven for displaying; and when subpixels in the second subpixel group are driven for displaying, blue subpixels in the second sub group are first driven for displaying.

6. A display apparatus, comprising:
a display panel, wherein the display panel comprises a plurality of pixel units; each of the plurality of pixel units comprises subpixels of at least three colors, the subpixels of each color comprises first-type subpixels and second-type subpixels, and wherein the first-type subpixels and the second-type subpixels are alternatively arranged in both of a row direction and a column direction of the pixel units arrangement, every 2N rows of subpixels are grouped as a subpixel group, odd-numbered rows of subpixels in the subpixel group are grouped as a first subpixel group, even-numbered rows of subpixels in the subpixel group are grouped as a second subpixel group, and n is an integer greater than 1; and
a driving circuit, which is configured to: for the subpixel group composed of 2N rows of subpixels, first drive one of the first subpixel group and the second subpixel group for displaying, and then drive the other one of the first subpixel group and the second subpixel group for displaying; wherein a level of a data signal supplied by the driving circuit to the first-type subpixels is different from a level of a data signal supplied by the driving circuit to the second-type subpixels.

7. The display apparatus of claim 6, wherein the display panel comprises a plurality of scanning lines and a plurality of data lines, subpixels in each row correspond to a same scanning line, and subpixels in each column correspond to a same data line;
when a row of subpixels are driven for displaying, the driving circuit is configured to supply a scanning signal via a scanning line corresponding to the row of subpixels, and supply the data signal via the data lines corresponding to the row of subpixels;
a period of changing a level of the data signal on each data line is 2N times of a duration of the scanning signal.

8. The display apparatus of claim 6, wherein each subpixel group comprises six rows of subpixels or twelve rows of subpixels, and subpixels in a same row are of a same color.

9. The display apparatus of claim 6, wherein the driving circuit is further configured to:
first drive blue subpixels in the first subpixel group for displaying during driving subpixels in the first subpixel group for displaying; and
first drive blue subpixels in the second sub group for displaying during driving subpixels in the second subpixel group for display.

10. The display apparatus of claim 6, wherein the driving circuit comprises a data driving circuit, a gate driving circuit, a controller, and a gamma voltage generator.

11. A PVA liquid crystal display panel, comprising:
3N gate lines extended in a first direction;
2M data lines extended in a second direction substantially perpendicular to the first direction; and
a plurality of pixel units arranged in N rows and M columns, wherein each of the plurality of pixel units comprises a red subpixel, a green subpixel and a blue subpixel which are sequentially arranged in the second direction, each of the red subpixel, the green subpixel and the blue subpixel comprises a high-gray region and a low-gray region arranged in the first direction, and each of the red subpixel, the green subpixel and the blue subpixel is coupled to one corresponding gate line and two corresponding data lines, where M is an integer greater than 1, and N is an even integer greater than 2,
wherein the plurality of pixel units are configured such that adjacent regions of each high-gray region are all low-gray regions and adjacent regions of each low-gray region are all high-gray regions, and
the red subpixel, the green subpixel and the blue subpixel are arranged in a subpixel array in 3N rows, and each row of the subpixel array is composed of subpixels of a same color.

12. The PVA liquid crystal display panel of claim 11, wherein the high-gray region is ahead of the low-gray region in a starting subpixel in each odd-numbered row of subpixel array, and the low-gray region is ahead of the high-gray region in a starting subpixel in each even-numbered row of subpixel array.

13. The PVA liquid crystal display panel of claim 11, wherein the low-gray region is ahead of the high-gray region in a starting subpixel in each odd-numbered row of subpixel array, and the high-gray region is ahead of the low-gray region in a starting subpixel in each even-numbered row of subpixel array.

14. The PVA liquid crystal display panel of claim 12, wherein the high-gray region receives a data signal corrected by a first gamma curve via a corresponding data line, and the low-gray region receives a data signal corrected by a second gamma curve via the corresponding data line.

15. The PVA liquid crystal display panel of claim 12, wherein for a same subpixel, a level of a data signal corrected by a first gamma curve and received by the high-gray region is higher than that of a data signal corrected by a second gamma curve and received by the low-gray region.

16. A driving method for the PVA liquid crystal display panel of claim 11, comprising:
dividing the subpixel array in 3N rows into a plurality of driving groups, wherein each of the plurality of driving groups comprises at least two rows of the plurality of pixel units that are arranged in N rows and m columns; and
sequentially driving the plurality of driving groups.

17. The driving method for the PVA liquid crystal display panel of claim 16, wherein when each of the plurality of driving groups is driven, odd-numbered rows of the driving group in the subpixel array are first sequentially driven, and then even-numbered rows of the driving group in the subpixel array are sequentially driven.

18. The driving method for the PVA liquid crystal display panel of claim 16, wherein when each of the plurality of driving groups is driven, even-numbered rows of the driving group in the subpixel array are first sequentially driven, and then odd-numbered rows of the driving group in the subpixel array are sequentially driven.

19. The PVA liquid crystal display panel of claim 17, wherein when odd-numbered rows of the driving group in the subpixel array are sequentially driven, one row composed of blue subpixels among the odd-numbered rows is finally driven.

20. The PVA liquid crystal display panel of claim 17, wherein when even-numbered rows of the driving group in the subpixel array are sequentially driven, one row composed of blue subpixels among the even-numbered rows is finally driven.
